(19) United States
(12) Patent Application Publication
(10) Pub. No.: US 2007/0278936 A1
(43) Pub. Date: Dec. 6, 2007

(54) Red emitter complexes of IR(III) and devices made with such compounds

(76) Inventors: Norman Herron, Newark, DE (US); Ying Wang, Wilmington, DE (US); Viacheslav A. Petrov, Hockessin, DE (US); Mark A. Guidry, New Castle, DE (US); Jeffrey A. Merlo, Wilmington, DE (US); Kerwin D. Dobbs, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/445,625

(22) Filed: Jun. 2, 2006

(51) Int. Cl. C07F 15/00; H01J 1/62

(52) U.S. Cl. 313/504; 546/2

(57) ABSTRACT

There are provided compounds of Formulae I and II:

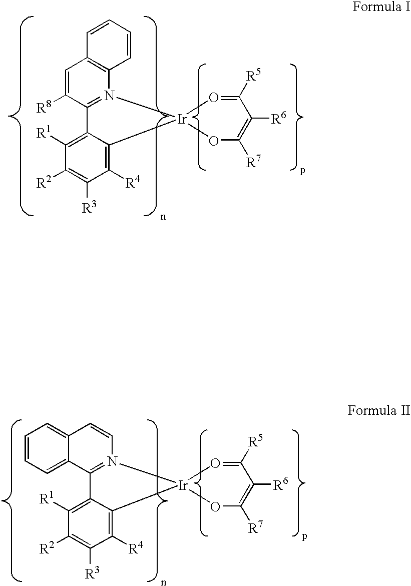

where:
n is 1, 2 or 3;
p is 0, 1 or 2;
the sum of n +p is 3;
R¹ R², R³ and R⁴ are each independently H, F, alkyl, trialkylsilyl, triarylsilyl, aryl or substituted aryl.
R⁵ and R⁷ are each independently alkyl or aryl; and
R⁶ is H or alkyl.
R⁸ is H, F, or alkyl

There are also provided electronic devices containing such compounds.

### BACKGROUND INFORMATION

1. Field of the Disclosure

This disclosure relates in general to red emitter complexes of IR(III). It also relates to devices in which the Ir complex is an active component.

2. Description of the Related Art

Organic electronic devices define a category of products that include an active layer. Such devices convert electrical energy into radiation, detect signals through electronic processes, convert radiation into electrical energy, or include one or more organic semiconductor layers. Organic light-emitting diodes (OLEDs) are an organic electronic device comprising an organic layer capable of electroluminescence. In some OLEDs, these photoactive organic layers comprise simple organic molecules, conjugated polymers, or organometallic complexes. Such photoactive organic layers can be sandwiched between electrical contact layers. When a voltage is applied across these electrical contact layers, the organic layer emits light. The emission of light from the photoactive organic layers in OLEDs may be used, for example, in electrical displays and microelectronic devices.

It is well known to use organic electroluminescent compounds as the active component in LEDs. Simple organic molecules such as anthracene, thiadiazole derivatives, and coumarin derivatives are known to show electroluminescence. Semiconductive conjugated polymers have also been used as electroluminescent components, as has been disclosed in, for example, Friend et al., U.S. Pat. No. 5,247,190, Heeger et al., U.S. Pat. No. 5,408,109, and Nakano et al., Published European Patent Application 443 861. Complexes of 8 hydroxyquinolate with trivalent metal ions, particularly aluminum, have been extensively used as electroluminescent components, as has been disclosed in, for example, Tang et al., U.S. Pat. No. 5,552,678.

Burrows and Thompson have reported that fac-tris(2-phenylpyridine) iridium can be used as the active component in organic light-emitting devices. (Appl. Phys. Lett. 1999, 75, 4.) The performance is maximized when the iridium compound is present in a host conductive material. Thompson has further reported devices in which the active layer is poly(N-vinyl carbazole) doped with fac-tris[2-(4′,5′-difluorophenyl)pyridine-C′2,N]iridium(III). (Polymer Preprints 2000, 41(1), 770).

### SUMMARY OF THE INVENTION

Provided are compounds having Formula I or Formula II

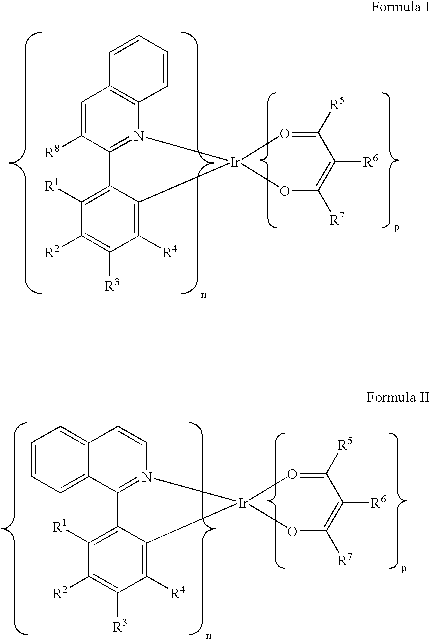

where:

n is 1, 2 or 3;

p is 0, 1 or 2;

the sum of n+p is 3;

R¹ R², R³ and R⁴ are each independently H, F, alkyl, alkoxyl, trialkylsilyl, triarylsilyl, aryl or substituted aryl.

R⁵ and R⁷ are each independently alkyl or aryl; and

R⁶ is H or alkyl.

R⁸ is H, F, or alkyl

with the proviso that at least one of R¹, R², R³, R⁴, and R⁸ is not H.

In some embodiments, R⁵ and R⁷ are methyl and R⁶ is H.

In some embodiments, also provided are compositions comprising the compounds of the invention. In another embodiment, the invention concerns electronic devices that comprise at least one active layer that includes at least one compound of the instant invention. In certain embodiments, the layer contains two or more of these compounds. In certain embodiments, the materials are processed by solution based techniques requiring enhanced solubility in organic solvents which may be provided by appropriate choice of substituents R¹ thru R⁸

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts as presented herein.

The invention is illustrated by way of example and not limitation in the accompanying figure.

FIG. 1 includes an illustrative example of an organic electronic device. Skilled artisans appreciate that objects in the figures are illustrated for simplicity and clarity and have not necessarily been drawn to scale.

For example, the dimensions of some of the objects in the figures may be exaggerated relative to other objects to help to improve understanding of embodiments.

### DETAILED DESCRIPTION

Provided are compounds having Formula I or Formula II

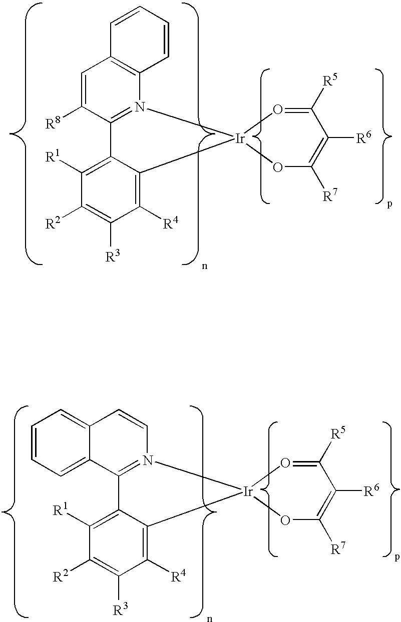

where:

n is 1, 2 or 3;

p is 0, 1 , or 2;

the sum of n+p is 3;

R¹ R², R³ and R⁴ are each independently H, F, alkyl, alkoxyl, trialkylsilyl, triarylsilyl, aryl or substituted aryl.

R⁵ and R⁷ are each independently alkyl or aryl; and

R⁶ is H or alkyl.

R⁸ is H, F, or alkyl, with the proviso that at least one of R¹, R², R³, R⁴, and R⁸ is not H.

Many aspects and embodiments have been described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims.

In some embodiments, n is 1 and p is 2. In other embodiments, n is 2 and p is 1. In still other embodiments, n is 3 and p is 0. In certain embodiments, the invention relates to a mixture of compounds (a) where n is 1 and p is 2 and (b) where n is 2 and p is 1

In certain embodiments, one or more of the compounds can be admixed with a polymer.

In some embodiments, the compounds have charge transport properties. For example, it may be desirable that an electron transport layer comprises compounds having electron transport properties. Also, the compounds having photoactivity make them suitable for photoactive layers such as an emitter layer.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

In one embodiment of the invention, at least one of the aforementioned compounds is included in at least one layer of an electronic device. For example, the compounds in accordance with the present invention can be used in a photoactive layer, in a charge transport layer, and both types of layers.

In some embodiments of the invention, the invention concerns an electronic device having at least one of the aforementioned compounds.

In some embodiments, the invention concerns a composition comprising at least one of the aforementioned compounds and at least one of a solvent, a process aid, or a polymer. Also provided are compositions comprising a compound of the instant invention, and a processing aid, a charge transporting material, a charge blocking material, or combinations thereof. These compositions can be in any form, including, but not limited to solvents, emulsions, and colloidal dispersions.

As used herein, the term “alkyl” includes both branched and straight-chain saturated aliphatic hydrocarbon groups having the specified number of carbon atoms. Unless otherwise indicated, the term is also intended to include cyclic groups. Examples of alkyl groups include methyl, ethyl, propyl, isopropyl, isobutyl, secbutyl, tertbutyl, pentyl, isopentyl cyclopentyl, hexyl, cyclohexyl, isohexyl and the like. The term “alkyl” further includes both substituted and unsubstituted hydrocarbon groups. In some embodiments, the alkyl group may be mono-, di- and tri-substituted. One example of a substituted alkyl group is trifluoromethyl. Other substituted alkyl groups are formed from one or more of the substituents described herein. In certain embodiments alkyl groups have 1 to 12 carbon atoms. In other embodiments, the group has 1 to 6 carbon atoms.

The term “aryl” means an aromatic carbocyclic moiety of up to 20 carbon atoms, which may be a single ring (monocyclic) or multiple rings (bicyclic, up to three rings) fused together or linked covalently. Any suitable ring position of the aryl moiety may be covalently linked to the defined chemical structure. Examples of aryl moieties include, but are not limited to, phenyl, 1-naphthyl, 2-naphthyl, dihydronaphthyl, tetrahydronaphthyl, biphenyl. anthryl, phenanthryl, fluorenyl, indanyl, biphenylenyl, acenaphthenyl, acenaphthylenyl, and the like. In some embodiments, aryl groups have 6 to 20 carbon atoms.

Unless otherwise indicated, all groups can be substituted or unsubstituted.

An optionally substituted group, such as, but not limited to, alkyl or aryl, may be substituted with one or more substituents which may be the same or different. Suitable substituents include alkyl, aryl, nitro, cyano, —N(R⁷)(R⁸), halo, hydroxy, carboxy, alkenyl, alkynyl, cycloalkyl, heteroaryl, alkoxy, aryloxy, heteroaryloxy, alkoxycarbonyl, perfluoroalkyl, perfluoroalkoxy, arylalkyl, thioalkoxy, —S(O)₂—N(R⁷)(R⁸), —C(═O)—N(R⁷)(R⁸), (R⁷)(R⁸)N-alkyl, (R⁷)(R⁸)N-alkoxyalkyl, (R⁷)(R⁸)N-alkylaryloxyalkyl, —S(O)ₛ— aryl (where s=0-2) or —S(O)ₛ-heteroaryl (where s=0-2). Each R⁷ and R⁸ is independently an optionally substituted alkyl, cylcoalkyl, or aryl group. R⁷ and R⁸, together with the nitrogen atom to which they are bound, can form a ring system in certain embodiments.

The prefix “hetero” indicates that one or more carbon atoms has been replaced with a different atom.

In addition, the IUPAC numbering system is used throughout, where the groups from the Periodic Table are numbered from left to right as 1 through 18 (CRC Handbook of Chemistry and Physics, 81^{st} Edition, 2000).

The term “group” is intended to mean a part of a compound, such as a substituent in an organic compound.

The term “film” is used interchangeably with the term “layer” and refers to a coating covering a desired area. The term is not limited by size. For example, in some embodiments, the area can be as large as an entire device. In other embodiments, the area can be as small as a specific functional area such as the actual visual display, or as small as a single sub-pixel. In addition, the area can be continuous or discontinuous. Films can be formed by any conventional deposition technique, including, but not limited to, vapor deposition, liquid deposition, and thermal transfer. For example, in some embodiments, the film may be made continuous deposition techniques such as by spin coating, gravure coating, curtain coating, dipcoating, slot-die coating, spray coating, continuous nozzle coating, and in other embodiments, the film may be formed by discontinuous deposition techniques such as ink jet printing, contact printing such as gravure printing, screen printing, and the like, or indeed, any other way which is effective in causing a film to come into existence.

The term “monomer” refers to a compound capable of being polymerized. The term “monomeric unit” refers to units which are repeated in a polymer.

The term “polymeric” is intended to encompass oligomeric species and include materials having 2 or more monomeric units.

The phrase “adjacent to,” when used to refer to layers in a device, does not necessarily mean that one layer is immediately next to another layer.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition A or B is satisfied by any one of the following: A is true (or present) and B is false (or not present), A is false (or not present) and B is true (or present), and both A and B are both true (or both present).

Also, “the”, “a” or “an” are employed to describe elements and components of the invention. This is done merely for convenience and to give a general sense of the invention. This description should be read to include one or at least one and the singular also includes the plural unless it is obvious that it is meant otherwise.

Group numbers corresponding to columns within the Periodic Table of the elements use the “New Notation” convention as seen in the CRC Handbook of Chemistry and Physics, 81^{st} Edition (2000-2001).

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductive member arts.

Organic electronic devices that may benefit from having one or more layers comprising at least one compound of instant invention include, but are not limited to, (1) devices that convert electrical energy into radiation (e.g., a light-emitting diode, light emitting diode display, or diode laser), (2) devices that detect signals through electronics processes (e.g., photodetectors, photoconductive cells, photoresistors, photoswitches, phototransistors, phototubes, IR detectors), (3) devices that convert radiation into electrical energy, (e.g., a photovoltaic device or solar cell), and (4) devices that include one or more electronic components that include one or more organic semi-conductor layers (e.g., a transistor or diode). Other uses for the compositions according to the present invention include coating materials for memory storage devices, antistatic films, biosensors, electrochromic devices, solid electrolyte capacitors, energy storage devices such as a rechargeable battery, and electromagnetic shielding applications.

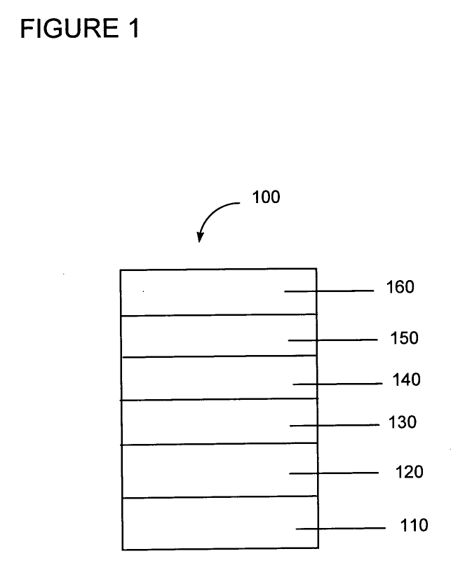

One illustration of an organic electronic device structure is shown in FIG. 1. The device 100 has an anode layer 110 and a cathode layer 160, and a photoactive layer 130 between them. Adjacent to the anode is a layer 120 comprising a charge transport layer, for example, a hole transport material. Adjacent to the cathode may be a charge transport layer 140 comprising an electron transport material. As an option, devices may use a further electron transport layer or hole transport layer 150, next to the cathode.

As used herein, the term “photoactive” refers to a material that emits light when activated by an applied voltage (such as in a light-emitting diode or light-emitting electrochemical cell), or responds to radiant energy and generates a signal with or without an applied bias voltage (such as in a photodetector). In one embodiment, a photoactive layer is an emitter layer.

As used herein, the term “charge transport,” when referring to a layer or material is intended to mean such layer or material facilitates migration of such charge through the thickness of such layer, material, member, or structure with relative efficiency and small loss of charge, and is meant to be broad enough to include materials that may act as a hole transport or an electron transport material. The term “electron transport” when referring to a layer or material means such a layer or material, member or structure that promotes or facilitates migration of electrons through such a layer or material into another layer, material, member or structure.

The term “charge blocking,” when referring to a layer, material, member, or structure, is intended to mean such layer, material, member or structure reduces the likelihood that a charge migrates into another layer, material, member or structure. The term “electron blocking” when referring to a layer, material, member or structure is intended to mean such layer, material, member or structure that reduces that likelihood that electrons migrate into another layer, material, member or structure.

Depending upon the application of the device 100, the photoactive layer 130 can be a light-emitting layer that is activated by an applied voltage (such as in a light-emitting diode or light-emitting electrochemical cell), a layer of material that responds to radiant energy and generates a signal with or without an applied bias voltage (such as in a photodetector). Examples of photodetectors include photoconductive cells, photoresistors, photoswitches, phototransistors, and phototubes, and photovoltaic cells, as these terms are described in Kirk-Othmer Concise Encyclopedia of Chemical Technology, 4^{th} edition, p. 1537, (1999).

In certain embodiments, a charge transport layer, for example, the electron transport layer 140 comprises at least one compound in accordance with the present invention.

In certain embodiments, the photoactive layer 130 comprises at least one compound in accordance with the present invention. Moreover, a photoactive material can further be admixed with the compound.

The other layers in the device can be made of any materials which are known to be useful in such layers. The anode 110, is an electrode that is particularly efficient for injecting positive charge carriers. It can be made of, for example materials containing a metal, mixed metal, alloy, metal oxide or mixed-metal oxide, or it can be a conducting polymer, and mixtures thereof. Suitable metals include the Group 11 metals, the metals in Groups 4, 5, and 6, and the Group 8 10 transition metals. If the anode is to be light-transmitting, mixed-metal oxides of Groups 12, 13 and 14 metals, such as indium-tin-oxide, are generally used. The anode 110 may also comprise an organic material such as polyaniline as described in “Flexible light-emitting diodes made from soluble conducting polymer,” Nature vol. 357, pp 477 479 (11 Jun. 1992). At least one of the anode and cathode should be at least partially transparent to allow the generated light to be observed.

The hole transport layer, which is a layer that facilitates the migration of negative charges through the layer into another layer of the electronic device, can include any number of materials. Examples of other hole transport materials for layer 120 have been summarized for example, in Kirk Othmer Encyclopedia of Chemical Technology, Fourth Edition, Vol. 18, p. 837 860, 1996, by Y. Wang. Both hole transporting molecules and polymers can be used. Commonly used hole transporting molecules include, but are not limited to: N,N′-diphenyl-N,N′-bis(3-methylphenyl)-[1,1′-biphenyl]4,4′-diamine (TPD), 1,1-bis[(di-4-tolylamino) phenyl]cyclohexane (TAPC), N,N′-bis(4-methylphenyl)-N,N′-bis(4-ethylphenyl)-[1,1′-(3,3′-dimethyl)biphenyl]-4,4′-diamine (ETPD), tetrakis (3-methylphenyl)-N,N,N′,N′-2,5-phenylenediamine (PDA), a-phenyl 4-N,N-diphenylaminostyrene (TPS), p-(diethylamino)benzaldehyde diphenylhydrazone (DEH), triphenylamine (TPA), bis[4(N,N-diethylamino)-2-methylphenyl](4-methylphenyl)methane (MPMP), 1-phenyl-3-[p-(diethylamino)styryl]-5-[p-(diethylamino)phenyl]pyrazoline (PPR or DEASP), 1,2-trans-bis(9H-carbazol-9-yl)cyclobutane (DCZB), N,N,N′, N′ tetrakis(4-methylphenyl)-(1,1′-biphenyl)-4,4′-diamine (TTB), N,N′-Bis(naphthalen-1-yl)-N,N′-bis-(phenyl)benzidine (□-NPB), and porphyrinic compounds, such as copper phthalocyanine. Commonly used hole transporting polymers include, but are not limited to, polyvinylcarbazole, (phenylmethyl)polysilane, and polyaniline. It is also possible to obtain hole transporting polymers by doping hole transporting molecules such as those mentioned above into polymers such as polystyrene and polycarbonate.

Any organic electroluminescent (“EL”) material can be used as the photoactive material in layer 130. Such materials include, but are not limited to, one of more compounds of the instant invention, small organic fluorescent compounds, fluorescent and phosphorescent metal complexes, conjugated polymers, and mixtures thereof. Examples of fluorescent compounds include, but are not limited to, pyrene, perylene, rubrene, coumarin, derivatives thereof, and mixtures thereof. Examples of metal complexes include, but are not limited to, metal chelated oxinoid compounds, such as tris(8-hydroxyquinolato)aluminum (Alq3); cyclometalated iridium and platinum electroluminescent compounds, and mixtures thereof. Examples of conjugated polymers include, but are not limited to poly(phenylenevinylenes), polyfluorenes, poly(spirobifluorenes), polythiophenes, poly(p-phenylenes), copolymers thereof, and mixtures thereof.

Examples of electron transport materials which can be used in the electron transport layer 140 and/or the optional layer 150 includes metal chelated oxinoid compounds, such as tris(8-hydroxyquinolato)aluminum (Alq3) and tetrakis-(8-hydroxyquinolato)zirconium (Zrq4); and azole compounds such as 2-(4-biphenylyl)-5-(4-t-butylphenyl)-1,3,4-oxadiazole (PBD), 3-(4-biphenylyl)4-phenyl-5-(4-t-butylphenyl)-1,2,4-triazole (TAZ), and 1,3,5-tri(phenyl-2-benzimidazole)benzene (TPBI); quinoxaline derivatives such as 2,3-bis(4-fluorophenyl)quinoxaline; phenanthrolines such as 4,7-diphenyl-1,10-phenanthroline (DPA) and 2,9-dimethyl-4,7-diphenyl-1,10-phenanthroline (DDPA); and mixtures thereof.

The cathode 160, is an electrode that is particularly efficient for injecting electrons or negative charge carriers. The cathode can be any metal or nonmetal having a lower work function than the anode. Materials for the cathode can be selected from alkali metals of Group 1 (e.g., Li, Cs), the Group 2 (alkaline earth) metals, the Group 12 metals, including the rare earth elements and lanthanides, and the actinides. Materials such as aluminum, indium, calcium, barium, samarium and magnesium, as well as combinations, can be used. Li-containing organometallic compounds, LiF, and Li₂O can also be deposited between the organic layer and the cathode layer to lower the operating voltage.

It is known to have other layers in organic electronic devices. For example, there can be a layer (not shown) between the anode 110 and hole transport layer 120 to facilitate positive charge transport and/or band-gap matching of the layers, or to function as a protective layer. Layers that are known in the art can be used. In addition, any of the above-described layers can be made of two or more layers. Alternatively, some or all of anode layer 110, the hole transport layer 120, the electron transport layer 140 and optional charge transport layer 150, and cathode layer 160, may be surface treated to increase charge carrier transport efficiency. The choice of materials for each of the component layers is preferably determined by balancing the goals of providing a device with high device efficiency with device operational lifetime.

The device can be prepared by a variety of techniques, including sequentially depositing the individual layers on a suitable substrate. Substrates such as glass and polymeric films can be used. Conventional vapor deposition techniques can be used, such as thermal evaporation, chemical vapor deposition, and the like. Alternatively, the organic layers can be applied by liquid deposition using suitable solvents. The liquid can be in the form of solutions, dispersions, or emulsions. Typical liquid deposition techniques include, but are not limited to, continuous deposition techniques such as spin coating, gravure coating, curtain coating, dip coating, slot-die coating, spray-coating, and continuous nozzle coating; and discontinuous deposition techniques such as ink jet printing, gravure printing, and screen printing. any conventional coating or printing technique, including but not limited to spin-coating, dip-coating, roll-to-roll techniques, ink jet printing, screen-printing, gravure printing and the like.

In one embodiment, the different layers have the following range of thicknesses: anode 110, 500-5000 Å, in one embodiment 1000-2000 Å; hole transport layer 120, 50-2000 Å, in one embodiment 200-1000 Å; photoactive layer 130, 10-2000 Å, in one embodiment 100-1000 Å; layers 140 and 150, 50-2000 Å, in one embodiment 100-1000 Å; cathode 160, 200-10000 Å, in one embodiment 300-5000 Å. The location of the electron-hole recombination zone in the device, and thus the emission spectrum of the device, can be affected by the relative thickness of each layer. Thus the thickness of the electron-transport layer should be chosen so that the electron-hole recombination zone is in the light-emitting layer. The desired ratio of layer thicknesses will depend on the exact nature of the materials used.

In one embodiment, the device has the following structure, in order: anode, buffer layer, hole transport layer, photoactive layer, electron transport layer, electron injection layer, cathode. In one embodiment, the anode is made of indium tin oxide or indium zinc oxide. In one embodiment, the buffer layer comprises a conducting polymer selected from the group consisting of polythiophenes, polyanilines, polypyrroles, copolymers thereof, and mixtures thereof. In one embodiment, the buffer layer comprises a complex of a conducting polymer and a colloid-forming polymeric acid. In one embodiment, the buffer layer comprises a compound having triarylamine or triarylmethane groups. In one embodiment, the buffer layer comprises a material selected from the group consisting of TPD, MPMP, NPB, CBP, and mixtures thereof, as defined above.

In one embodiment, the hole transport layer comprises polymeric hole transport material. In one embodiment, the hole transport layer is crosslinkable. In one embodiment, the hole transport layer comprises a compound having triarylamine or triarylmethane groups. In one embodiment, the buffer layer comprises a material selected from the group consisting of TPD, MPMP, NPB, CBP, and mixtures thereof, as defined above.

In one embodiment, the photoactive layer comprises an electroluminescent metal complex and a host material. The host can be a charge transport material. In one embodiment, the electroluminescent complex is present in an amount of at least 1% by weight. In one embodiment, the electroluminescent complex is 2-20% by weight. In one embodiment, the electroluminescent complex is 20-50% by weight. In one embodiment, the electroluminescent complex is 50-80% by weight. In one embodiment, the electroluminescent complex is 80-99% by weight. In one embodiment, the metal complex is a cyclometalated complex of iridium, platinum, rhenium, or osmium. In one embodiment, the photoactive layer further comprises a second host material. The second host can be a charge transport material. In one embodiment, the second host is a hole transport material. In one embodiment, the second host is an electron transport material. In one embodiment, the second host material is a metal complex of a hydroxyaryl-N-heterocycle. In one embodiment, the hydroxyaryl-N-heterocycle is unsubstituted or substituted 8-hydroxyquinoline. In one embodiment, the metal is aluminum. In one embodiment, the second host is a material selected from the group consisting of tris(8-hydroxyquinolinato)aluminum, bis(8-hydroxyquinolinato)(4-phenylphenolato)aluminum, tetrakis(8-hydroxyquinolinato)zirconium, and mixtures thereof. The ratio of the first host to the second host can be 1:100 to 100:1. In one embodiment the ratio is from 1:10 to 10:1. In one embodiment, the ratio is from 1:10 to 1:5. In one embodiment, the ratio is from 1:5 to 1:1. In one embodiment, the ratio is from 1:1 to 5:1. In one embodiment, the ratio is from 5:1 to 5:10.

In one embodiment, the electron transport layer comprises a metal complex of a hydroxyaryl-N-heterocycle. In one embodiment, the hydroxyaryl-N-heterocycle is unsubstituted or substituted 8-hydroxyquinoline. In one embodiment, the metal is aluminum. In one embodiment, the electron transport layer comprises a material selected from the group consisting of tris(8-hydroxyquinolinato)aluminum, bis(8-hydroxyquinolinato)(4-phenylphenolato)aluminum, tetrakis(8-hydroxyquinolinato)zirconium, and mixtures thereof. In one embodiment, the electron injection layer is LiF or LiO₂. In one embodiment, the cathode is Al or Ba/Al.

In one embodiment, the device is fabricated by liquid deposition of the buffer layer, the hole transport layer, and the photoactive layer, and by vapor deposition of the electron transport layer, the electron injection layer, and the cathode.

The buffer layer can be deposited from any liquid medium in which it is dissolved or dispersed and from which it will form a film. In one embodiment, the liquid medium consists essentially of one or more organic solvents. In one embodiment, the liquid medium consists essentially of water or water and an organic solvent. In one embodiment the organic solvent is selected from the group consisting of alcohols, ketones, cyclic ethers, and polyols. In one embodiment, the organic liquid is selected from dimethylacetamide (“DMAc”), N-methylpyrrolidone (“NMP”), dimethylformamide (“DMF”), ethylene glycol (“EG”), aliphatic alcohols, and mixtures thereof. The buffer material can be present in the liquid medium in an amount from 0.5 to 10 percent by weight. Other weight percentages of buffer material may be used depending upon the liquid medium. The buffer layer can be applied by any continuous or discontinuous liquid deposition technique. In one embodiment, the buffer layer is applied by spin coating. In one embodiment, the buffer layer is applied by ink jet printing. After liquid deposition, the liquid medium can be removed in air, in an inert atmosphere, or by vacuum, at room temperature or with heating. In one embodiment, the layer is heated to a temperature less than 275° C. In one embodiment, the heating temperature is between 100° C. and 275° C. In one embodiment, the heating temperature is between 100° C. and 120° C. In one embodiment, the heating temperature is between 120° C. and 140° C. In one embodiment, the heating temperature is between 140° C. and 160° C. In one embodiment, the heating temperature is between 160° C. and 180° C. In one embodiment, the heating temperature is between 180° C. and 200° C. In one embodiment, the heating temperature is between 200° C. and 220° C. In one embodiment, the heating temperature is between 190° C. and 220° C. In one embodiment, the heating temperature is between 220° C. and 240° C. In one embodiment, the heating temperature is between 240° C. and 260° C. In one embodiment, the heating temperature is between 260° C. and 275° C. The heating time is dependent upon the temperature, and is generally between 5 and 60 minutes. In one embodiment, the final layer thickness is between 5 and 200 nm. In one embodiment, the final layer thickness is between 5 and 40 nm. In one embodiment, the final layer thickness is between 40 and 80 nm. In one embodiment, the final layer thickness is between 80 and 120 nm. In one embodiment, the final layer thickness is between 120 and 160 nm. In one embodiment, the final layer thickness is between 160 and 200 nm.

The hole transport layer can be deposited from any liquid medium in which it is dissolved or dispersed and from which it will form a film. In one embodiment, the liquid medium consists essentially of one or more organic solvents. In one embodiment, the liquid medium consists essentially of water or water and an organic solvent. In one embodiment the organic solvent is an aromatic solvent. In one embodiment, the organic liquid is selected from chloroform, dichloromethane, toluene, anisole, and mixtures thereof. The hole transport material can be present in the liquid medium in a concentration of 0.2 to 2 percent by weight. Other weight percentages of hole transport material may be used depending upon the liquid medium. The hole transport layer can be applied by any continuous or discontinuous liquid deposition technique. In one embodiment, the hole transport layer is applied by spin coating. In one embodiment, the hole transport layer is applied by ink jet printing. After liquid deposition, the liquid medium can be removed in air, in an inert atmosphere, or by vacuum, at room temperature or with heating. In one embodiment, the layer is heated to a temperature less than 275° C. In one embodiment, the heating temperature is between 170° C. and 275° C. In one embodiment, the heating temperature is between 170° C. and 200° C. In one embodiment, the heating temperature is between 190° C. and 220° C. In one embodiment, the heating temperature is between 210° C. and 240° C. In one embodiment, the heating temperature is between 230° C. and 270° C. The heating time is dependent upon the temperature, and is generally between 5 and 60 minutes. In one embodiment, the final layer thickness is between 5 and 50 nm. In one embodiment, the final layer thickness is between 5 and 15 nm. In one embodiment, the final layer thickness is between 15 and 25 nm. In one embodiment, the final layer thickness is between 25 and 35 nm. In one embodiment, the final layer thickness is between 35 and 50 nm.

The photoactive layer can be deposited from any liquid medium in which it is dissolved or dispersed and from which it will form a film. In one embodiment, the liquid medium consists essentially of one or more organic solvents. In one embodiment, the liquid medium consists essentially of water or water and an organic solvent. In one embodiment the organic solvent is an aromatic solvent. In one embodiment, the organic liquid is selected from chloroform, dichloromethane, toluene, anisole, and mixtures thereof. The photoactive material can be present in the liquid medium in a concentration of 0.2 to 2 percent by weight. Other weight percentages of photoactive material may be used depending upon the liquid medium. The photoactive layer can be applied by any continuous or discontinuous liquid deposition technique. In one embodiment, the photoactive layer is applied by spin coating. In one embodiment, the photoactive layer is applied by ink jet printing. After liquid deposition, the liquid medium can be removed in air, in an inert atmosphere, or by vacuum, at room temperature or with heating. In one embodiment, the deposited layer is heated to a temperature that is less than the Tg of the material having the lowest Tg. In one embodiment, the heating temperature is at least 10° C. less than the lowest Tg. In one embodiment, the heating temperature is at least 20° C. less than the lowest Tg. In one embodiment, the heating temperature is at least 30° C. less than the lowest Tg. In one embodiment, the heating temperature is between 50° C. and 150° C. In one embodiment, the heating temperature is between 50° C. and 75° C. In one embodiment, the heating temperature is between 75° C. and 100° C. In one embodiment, the heating temperature is between 100° C. and 125° C. In one embodiment, the heating temperature is between 125° C. and 150° C. The heating time is dependent upon the temperature, and is generally between 5 and 60 minutes. In one embodiment, the final layer thickness is between 25 and 100 nm. In one embodiment, the final layer thickness is between 25 and 40 nm. In one embodiment, the final layer thickness is between 40 and 65 nm. In one embodiment, the final layer thickness is between 65 and 80 nm. In one embodiment, the final layer thickness is between 80 and 100 nm.

The electron transport layer can be deposited by any vapor deposition method. In one embodiment, it is deposited by thermal evaporation under vacuum. In one embodiment, the final layer thickness is between 1 and 100 nm. In one embodiment, the final layer thickness is between 1 and 15 nm. In one embodiment, the final layer thickness is between 15 and 30 nm. In one embodiment, the final layer thickness is between 30 and 45 nm. In one embodiment, the final layer thickness is between 45 and 60 nm. In one embodiment, the final layer thickness is between 60 and 75 nm. In one embodiment, the final layer thickness is between 75 and 90 nm. In one embodiment, the final layer thickness is between 90 and 100 nm.

The electron injection layer can be deposited by any vapor deposition method. In one embodiment, it is deposited by thermal evaporation under vacuum. In one embodiment, the vacuum is less than 10⁻⁶ torr. In one embodiment, the vacuum is less than 10⁻⁷ torr. In one embodiment, the vacuum is less than 10⁻⁸ torr. In one embodiment, the material is heated to a temperature in the range of 100° C. to 400° C.; 150° C. to 350° C. preferably. In one embodiment, the material is deposited at a rate of 0.5 to 10 Å/sec. In one embodiment, the material is deposited at a rate of 0.5 to 1 Å/sec. In one embodiment, the material is deposited at a rate of 1 to 2 Å/sec. In one embodiment, the material is deposited at a rate of 2 to 3 Å/sec. In one embodiment, the material is deposited at a rate of 3 to 4 Å/sec. In one embodiment, the material is deposited at a rate of 4 to 5 Å/sec. In one embodiment, the material is deposited at a rate of 5 to 6 Å/sec. In one embodiment, the material is deposited at a rate of 6 to 7 Å/sec. In one embodiment, the material is deposited at a rate of 7 to 8 Å/sec. In one embodiment, the material is deposited at a rate of 8 to 9 Å/sec. In one embodiment, the material is deposited at a rate of 9 to 10 Å/sec. In one embodiment, the final layer thickness is between 0.1 and 3 nm. In one embodiment, the final layer thickness is between 0.1 and 1 nm. In one embodiment, the final layer thickness is between 1 and 2 nm. In one embodiment, the final layer thickness is between 2 and 3 nm.

The cathode can be deposited by any vapor deposition method. In one embodiment, it is deposited by thermal evaporation under vacuum. In one embodiment, the vacuum is less than 10⁻⁶ torr. In one embodiment, the vacuum is less than 10⁻⁷ torr. In one embodiment, the vacuum is less than 10⁻⁸ torr. In one embodiment, the material is heated to a temperature in the range of 100° C. to 400° C.; 150° C. to 350° C. preferably. In one embodiment, the material is deposited at a rate of 0.5 to 10 Å/sec. In one embodiment, the material is deposited at a rate of 0.5 to 1 Å/sec. In one embodiment, the material is deposited at a rate of 1 to 2 Å/sec. In one embodiment, the material is deposited at a rate of 2 to 3 Å/sec. In one embodiment, the material is deposited at a rate of 3 to 4 Å/sec. In one embodiment, the material is deposited at a rate of 4 to 5 Å/sec. In one embodiment, the material is deposited at a rate of 5 to 6 Å/sec. In one embodiment, the material is deposited at a rate of 6 to 7 Å/sec. In one embodiment, the material is deposited at a rate of 7 to 8 Å/sec. In one embodiment, the material is deposited at a rate of 8 to 9 Å/sec. In one embodiment, the material is deposited at a rate of 9 to 10 Å/sec. In one embodiment, the final layer thickness is between 10 and 10000 nm. In one embodiment, the final layer thickness is between 10 and 1000 nm. In one embodiment, the final layer thickness is between 10 and 50 nm. In one embodiment, the final layer thickness is between 50 and 100 nm. In one embodiment, the final layer thickness is between 100 and 200 nm. In one embodiment, the final layer thickness is between 200 and 300 nm. In one embodiment, the final layer thickness is between 300 and 400 nm. In one embodiment, the final layer thickness is between 400 and 500 nm. In one embodiment, the final layer thickness is between 500 and 600 nm. In one embodiment, the final layer thickness is between 600 and 700 nm. In one embodiment, the final layer thickness is between 700 and 800 nm. In one embodiment, the final layer thickness is between 800 and 900 nm. In one embodiment, the final layer thickness is between 900 and 1000 nm. In one embodiment, the final layer thickness is between 1000 and 2000 nm. In one embodiment, the final layer thickness is between 2000 and 3000 nm. In one embodiment, the final layer thickness is between 3000 and 4000 nm. In one embodiment, the final layer thickness is between 4000 and 5000 nm. In one embodiment, the final layer thickness is between 5000 and 6000 nm. In one embodiment, the final layer thickness is between 6000 and 7000 nm. In one embodiment, the final layer thickness is between 7000 and 8000 nm. In one embodiment, the final layer thickness is between 8000 and 9000 nm. In one embodiment, the final layer thickness is between 9000 and 10000 nm.

In one embodiment, the device is fabricated by vapor deposition of the buffer layer, the hole transport layer, and the photoactive layer, the electron transport layer, the electron injection layer, and the cathode.

In one embodiment, the buffer layer is applied by vapor deposition. In one embodiment, it is deposited by thermal evaporation under vacuum. In one embodiment, the vacuum is less than 10⁻⁶ torr. In one embodiment, the vacuum is less than 10⁻⁷ torr. In one embodiment, the vacuum is less than 10⁻⁸ torr. In one embodiment, the material is heated to a temperature in the range of 100° C. to 400° C.; 150° C. to 350° C. preferably. In one embodiment, the material is deposited at a rate of 0.5 to 10 Å/sec. In one embodiment, the material is deposited at a rate of 0.5 to 1 Å/sec. In one embodiment, the material is deposited at a rate of 1 to 2 Å/sec. In one embodiment, the material is deposited at a rate of 2 to 3 Å/sec. In one embodiment, the material is deposited at a rate of 3 to 4 Å/sec. In one embodiment, the material is deposited at a rate of 4 to 5 Å/sec. In one embodiment, the material is deposited at a rate of 5 to 6 Å/sec. In one embodiment, the material is deposited at a rate of 6 to 7 Å/sec. In one embodiment, the material is deposited at a rate of 7 to 8 Å/sec. In one embodiment, the material is deposited at a rate of 8 to 9 Å/sec. In one embodiment, the material is deposited at a rate of 9 to 10 Å/sec. In one embodiment, the final layer thickness is between 5 and 200 nm. In one embodiment, the final layer thickness is between 5 and 30 nm. In one embodiment, the final layer thickness is between 30 and 60 nm. In one embodiment, the final layer thickness is between 60 and 90 nm. In one embodiment, the final layer thickness is between 90 and 120 nm. In one embodiment, the final layer thickness is between 120 and 150 nm. In one embodiment, the final layer thickness is between 150 and 280 nm. In one embodiment, the final layer thickness is between 180 and 200 nm.

In one embodiment, the hole transport layer is applied by vapor deposition. In one embodiment, it is deposited by thermal evaporation under vacuum. In one embodiment, the vacuum is less than 10⁻⁶ torr. In one embodiment, the vacuum is less than 10⁻⁷ torr. In one embodiment, the vacuum is less than 10⁻⁸ torr. In one embodiment, the material is heated to a temperature in the range of 100° C. to 400° C.; 150° C. to 350° C. preferably. In one embodiment, the material is deposited at a rate of 0.5 to 10 Å/sec. In one embodiment, the material is deposited at a rate of 0.5 to 1 Å/sec. In one embodiment, the material is deposited at a rate of 1 to 2 Å/sec. In one embodiment, the material is deposited at a rate of 2 to 3 Å/sec. In one embodiment, the material is deposited at a rate of 3 to 4 Å/sec. In one embodiment, the material is deposited at a rate of 4 to 5 Å/sec. In one embodiment, the material is deposited at a rate of 5 to 6 Å/sec. In one embodiment, the material is deposited at a rate of 6 to 7 Å/sec. In one embodiment, the material is deposited at a rate of 7 to 8 Å/sec. In one embodiment, the material is deposited at a rate of 8 to 9 Å/sec. In one embodiment, the material is deposited at a rate of 9 to 10 Å/sec. In one embodiment, the final layer thickness is between 5 and 200 nm. In one embodiment, the final layer thickness is between 5 and 30 nm. In one embodiment, the final layer thickness is between 30 and 60 nm. In one embodiment, the final layer thickness is between 60 and 90 nm. In one embodiment, the final layer thickness is between 90 and 120 nm. In one embodiment, the final layer thickness is between 120 and 150 nm. In one embodiment, the final layer thickness is between 150 and 280 nm. In one embodiment, the final layer thickness is between 180 and 200 nm.

In one embodiment, the photoactive layer is applied by vapor deposition. In one embodiment, it is deposited by thermal evaporation under vacuum. In one embodiment, the photoactive layer consists essentially of a single electroluminescent compound, which is deposited by thermal evaporation under vacuum. In one embodiment, the vacuum is less than 10⁻⁶ torr. In one embodiment, the vacuum is less than 10⁻⁷ torr. In one embodiment, the vacuum is less than 10⁻⁸ torr. In one embodiment, the material is heated to a temperature in the range of 100° C. to 400° C.; 150° C. to 350° C. preferably. In one embodiment, the material is deposited at a rate of 0.5 to 10 Å/sec. In one embodiment, the material is deposited at a rate of 0.5 to 1 Å/sec. In one embodiment, the material is deposited at a rate of 1 to 2 Å/sec. In one embodiment, the material is deposited at a rate of 2 to 3 Å/sec. In one embodiment, the material is deposited at a rate of 3 to 4 Å/sec. In one embodiment, the material is deposited at a rate of 4 to 5 Å/sec. In one embodiment, the material is deposited at a rate of 5 to 6 Å/sec. In one embodiment, the material is deposited at a rate of 6 to 7 Å/sec. In one embodiment, the material is deposited at a rate of 7 to 8 Å/sec. In one embodiment, the material is deposited at a rate of 8 to 9 Å/sec. In one embodiment, the material is deposited at a rate of 9 to 10 Å/sec. In one embodiment, the final layer thickness is between 5 and 200 nm. In one embodiment, the final layer thickness is between 5 and 30 nm. In one embodiment, the final layer thickness is between 30 and 60 nm. In one embodiment, the final layer thickness is between 60 and 90 nm. In one embodiment, the final layer thickness is between 90 and 120 nm. In one embodiment, the final layer thickness is between 120 and 150 nm. In one embodiment, the final layer thickness is between 150 and 280 nm. In one embodiment, the final layer thickness is between 180 and 200 nm.

In one embodiment, the photoactive layer comprises two electroluminescent materials, each of which is applied by thermal evaporation under vacuum. Any of the above listed vacuum conditions and temperatures can be used. Any of the above listed deposition rates can be used. The relative deposition rates can be from 50:1 to 1:50. In one embodiment, the relative deposition rates are from 1:1 to 1:3. In one embodiment, the relative deposition rates are from 1:3 to 1:5. In one embodiment, the relative deposition rates are from 1:5 to 1:8. In one embodiment, the relative deposition rates are from 1:8 to 1:10. In one embodiment, the relative deposition rates are from 1:10 to 1:20. In one embodiment, the relative deposition rates are from 1:20 to 1:30. In one embodiment, the relative deposition rates are from 1:30 to 1:50. The total thickness of the layer can be the same as that described above for a single-component photoactive layer.

In one embodiment, the photoactive layer comprises one electroluminescent material and at least one host material, each of which is applied by thermal evaporation under vacuum. Any of the above listed vacuum conditions and temperatures can be used. Any of the above listed deposition rates can be used. The relative deposition rate of electroluminescent material to host can be from 1:1 to 1:99. In one embodiment, the relative deposition rates are from 1:1 to 1:3. In one embodiment, the relative deposition rates are from 1:3 to 1:5. In one embodiment, the relative deposition rates are from 1:5 to 1:8. In one embodiment, the relative deposition rates are from 1:8 to 1:10. In one embodiment, the relative deposition rates are from 1:10 to 1:20. In one embodiment, the relative deposition rates are from 1:20 to 1:30. In one embodiment, the relative deposition rates are from 1:30 to 1:40. In one embodiment, the relative deposition rates are from 1:40 to 1:50. In one embodiment, the relative deposition rates are from 1:50 to 1:60. In one embodiment, the relative deposition rates are from 1:60 to 1:70. In one embodiment, the relative deposition rates are from 1:70 to 1:80. In one embodiment, the relative deposition rates are from 1:80 to 1:90. In one embodiment, the relative deposition rates are from 1:90 to 1:99. The total thickness of the layer can be the same as that described above for a single-component photoactive layer.

In one embodiment, the electron transport layer is applied by vapor deposition. In one embodiment, it is deposited by thermal evaporation under vacuum. In one embodiment, the vacuum is less than 10⁻⁶ torr. In one embodiment, the vacuum is less than 10⁻⁷ torr. In one embodiment, the vacuum is less than 10⁻⁸ torr. In one embodiment, the material is heated to a temperature in the range of 100° C. to 400° C.; 150° C. to 350° C. preferably. In one embodiment, the material is deposited at a rate of 0.5 to 10 Å/sec. In one embodiment, the material is deposited at a rate of 0.5 to 1 Å/sec. In one embodiment, the material is deposited at a rate of 1 to 2 Å/sec. In one embodiment, the material is deposited at a rate of 2 to 3 Å/sec. In one embodiment, the material is deposited at a rate of 3 to 4 Å/sec. In one embodiment, the material is deposited at a rate of 4 to 5 Å/sec. In one embodiment, the material is deposited at a rate of 5 to 6 Å/sec. In one embodiment, the material is deposited at a rate of 6 to 7 Å/sec. In one embodiment, the material is deposited at a rate of 7 to 8 Å/sec. In one embodiment, the material is deposited at a rate of 8 to 9 Å/sec. In one embodiment, the material is deposited at a rate of 9 to 10 Å/sec. In one embodiment, the final layer thickness is between 5 and 200 nm. In one embodiment, the final layer thickness is between 5 and 30 nm. In one embodiment, the final layer thickness is between 30 and 60 nm. In one embodiment, the final layer thickness is between 60 and 90 nm. In one embodiment, the final layer thickness is between 90 and 120 nm. In one embodiment, the final layer thickness is between 120 and 150 nm. In one embodiment, the final layer thickness is between 150 and 280 nm. In one embodiment, the final layer thickness is between 180 and 200 nm.

In one embodiment, the electron injection layer is applied by vapor deposition, as described above.

In one embodiment, the cathode is applied by vapor deposition, as describe above.

In one embodiment, the device is fabricated by vapor deposition of some of the organic layers, and liquid deposition of some of the organic layers. In one embodiment, the device is fabricated by liquid deposition of the buffer layer, and vapor deposition of all of the other layers Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety.

### EXAMPLES

The concepts described herein will be further described in the following examples, which do not limit the scope of the invention described in the claims.

### Example 1

This example illustrates the preparation of emissive material

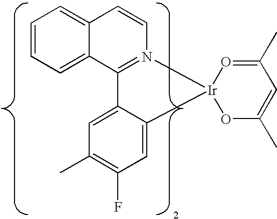

with structure:
1a—Preparation of the Phenylisoquinoline Ligand

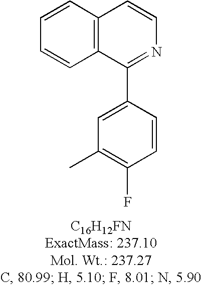

A mixture of 30 g of K₂CO₃, 250 ml of degassed water, 10 g (0.061 mol) of 1-chloroisoquinoiline, 10 g (0.065 mol) of 3-methyl-4-fluorophenylboronic acid, 0.3 g of (Ph₄P)Pd, 300 mL of dimethoxyethane was refluxed for 12 h. The organic phase was separated, and the water phase was extracted with CH₂C₁₂ (100 ml×3), and the combined organic layer was washed with water (300 mL×2), dried over MgSO₄, and solvent was removed under reduced pressure. The residue was redissolved in hexane (200 mL) and filtered through a short silicagel plug and solvent was removed to give 10.3 g (62%) of oily product, containing 4% of solvent(NMR). ¹H and ¹⁹F NMR spectra were consistent with the structure indicated above. Material was used for cyclometallation step without further purification.

1b—Preparation of the Bis Cyclometallated Iridium Complex of Ligand from 1a.

4.8 g phenylisoquinoline ligand prepared in 1a above and 3.6 g iridium chloride were mixed into 50 mL 2-ethoxyethanol, and 1 mL water. This mixture was refluxed under nitrogen for 30 mins. The slurry was then cooled and 2.0 g 2,4-pentanedione and 1.0 g sodium carbonate were added. The slurry was reheated to reflux for at least 30 more mins. The reaction progress was monitored by TLC following production of a fast running red luminescent spot when eluting with methylene chloride. The slurry was cooled and methanol/water was added to precipitate the product as a sticky red solid which was then collected by filtration. The recovered solid was extracted into methylene chloride and filtered through silica. The red solution was evaporated to dryness and chromatographed through a silica column eluting with methylene chloride to isolate the fastest running red luminescent fraction. The resulting deep red solution contains bright red luminescent material. The solution in methylene chloride was concentrated whereupon the product crystallized from the solvent as dark red blocks. ¹H and ¹⁹F NMR Spectra were consistent with the structure of the above complex.

### Example 2

This example illustrates the preparation of emissive material with structure:

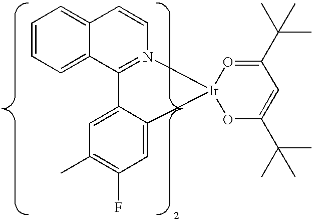

2.4 g phenylisoquinoline ligand from example 1a above and 1.8 g iridium chloride were mixed into 50 mL 2-ethoxyethanol, and 1 mL water. This mixture was refluxed under nitrogen for 30 mins then cooled to room temperature whereupon 1.0 g 2,2,6,6-tetramethyl-3,5-heptanedione and 1.0 g sodium carbonate were added. The slurry was returned to reflux for at least 30 more mins. The reaction progress was monitored by TLC following production of a fast running red luminescent spot when eluting with methylene chloride. The slurry was cooled and methanol/water was added to precipitate the product as a sticky red solid which was then collected by filtration. The recovered solid was extracted into methylene chloride and filtered through silica. The red solution was evaporated to dryness and chromatographed through a silica column eluting with methylene chloride to isolate the fastest running red luminescent fraction. The resulting deep red solution contains bright red luminescent material. The deep red solution was evaporated to ˜25 mL then methanol was added and the solution allowed to cool and dark red crystals form as jagged needles. The recrystallized material was from hot toluene. ¹H and ¹⁹F NMR Spectra were consistent with the structure of the above complex.

### Example 3

This example illustrates the preparation of emissive material with structure:

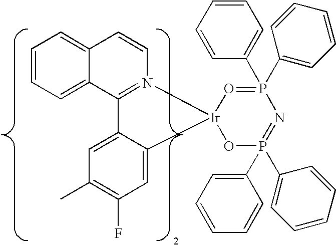

0.48 g phenylisoquinoline ligand from example 1a and 0.36 g iridium chloride were mixed in 10 mL 2-ethoxyethanol, and 1 mL water. This mixture was refluxed under nitrogen for 30 mins. The solution was cooled to room temperature and 0.42 g of the PNP ligand and 1.0 g sodium carbonate were added as solids to the mix. Reflux was resumed for at least 30 more mins. The progress of the reaction was monitored by TLC and when judged complete the slurry was cooled and methanol/water was added and the resulting red sticky solid was collected by filtration. The solid was extracted into methylene chloride and the red solution filtered through a silica plug and the resulting solution evaporated to low volume and methanol added to initiate crystallization. Over 2 hrs red crystals form. Recover the red crystals (bright red PL) which are very poorly soluble in toluene in −400 mg yield. Nmr in methylene chloride indicates that the material is the desired product

### Example 4

This example illustrates the preparation of emissive material with structure:

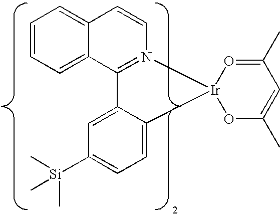

4a Preparation of Phenyl Isoquinoline Ligand with Structure:

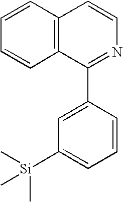

As described in Example 1a, but using a mixture of 20 g of K₂CO₃, 250 ml of degassed water, 5 g (0.03 mol) of 1-chloroisoquinoline, 6.5 g (0.033 mol) of 3-trimethylsilylphenylboronic acid, 0.2 g of (Ph₄P)Pd, 300 mL of dimethoxyethane was refluxed for 12 h. 6.1 g of desired material was isolated (72%, 0.96% purity) as a yellow oil, which was used for the next step without further purification ¹H NMR of isolated material was consistent with the structure indicated above.

4b Preparation of the Biscyclometallated Iridium Complex of Ligand 4a:

2.8 g phenylisoquinoline ligand from example 4a and 1.8 g iridium chloride were mixed in 25 mL 2-ethoxyethanol, and 1 mL water. This mixture was refluxed under nitrogen for 2 mins. At which point 1.0 g sodium bicarbonate was added as a solid and the reflux was continued for 30 mins. The solution was cooled to room temperature and 1.5 g of 2,4-pentanedione and 0.5 g sodium carbonate were added as solids to the mix. Reflux was resumed for at least 30 more mins. The progress of the reaction was monitored by TLC and when judged complete the slurry was evaporated to dryness in a nitrogen stream and the resulting red sticky solid was collected. The solid was extracted into methylene chloride and the red solution filtered through a silica plug and the resulting solution evaporated to low volume and then chromatographed on a silica column eluting with methylene chloride. The fastest running red band was collected and evaporated to low volume and then methanol was added to induce crystallization. Nmr spectroscopy in methylene chloride shows the product to be the expected compound slightly contaminated with the material from Example 5.

### Example 5

This example illustrates the preparation of emissive material

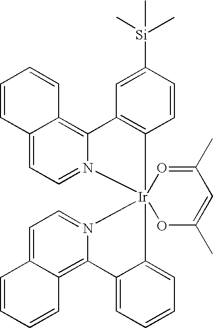

with structure

2.8 g phenylisoquinoline ligand from example 4a and 1.8 g iridium chloride were mixed in 25 mL 2-ethoxyethanol, and 1 mL water. This mixture was refluxed under nitrogen for 30 mins. The solution was cooled to room temperature and 1.5 g of 2,4-pentanedione and 1.0 g sodium carbonate were added as solids to the mix. Reflux was resumed for at least 30 more mins. The progress of the reaction was monitored by TLC and when judged complete the slurry was evaporated to dryness in a nitrogen stream and the resulting red sticky solid was collected. The solid was extracted into methylene chloride and the red solution filtered through a silica plug and the resulting solution evaporated to low volume and then chromatographed on a silica column eluting with methylene chloride and which revealed 3 distinct red luminescent bands. The fastest running red band was the material of example 4b. The second red band was collected and evaporated to low volume and then methanol was added to induce crystallization. Nmr spectroscopy in methylene chloride shows the product to be the expected compound slightly contaminated with the material from Example 4b.

### Example 6

This example illustrates the preparation of emissive material

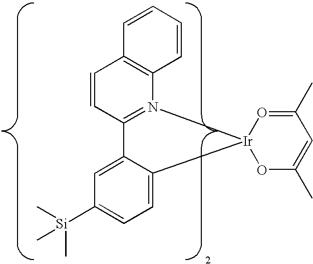

with structure:
6a Preparation of the Phenylquinoline Ligand with Structure:

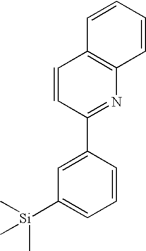

As described in Example 1a, but using a mixture of 22 g of K₂CO₃, 250 ml of degassed water, 5 g (0.029 mol) of 2-chloroquinoline, 6.5 g (0.033 mol) of 3-trimethylsilylphenylboronic acid, 0.2 g of (Ph₄P)Pd, 300 mL of dimethoxyethane was refluxed for 12 h. 5.9 g of the desired material was isolated (71%, 0.96% purity, NMR) as a yellow oil, which was used for next step without further purification. ¹H NMR of isolated material was consistent with the structure indicated above.

6b Preparation of Bis-Cyclometalated Iridium Complex of Ligand 6a:

2.8 g phenylquinoline ligand from example 6a and 1.8 g iridium chloride were mixed in 25 mL 2-ethoxyethanol, and 1 mL water. This mixture was refluxed under nitrogen for 2 mins at which point the solution was cooled and 1.0 g sodium bicarbonate was added. Reflux was then continued for a further 30 mins. The solution was cooled to room temperature and 1.5 g of 2,4-pentanedione and 1.0 g sodium carbonate were added as solids to the mix. Reflux was resumed for at least 30 more mins. The progress of the reaction was monitored by TLC and when judged complete the slurry was evaporated to dryness in a nitrogen stream and the resulting red sticky solid was collected. The solid was extracted into methylene chloride and the red solution filtered through a silica plug and the resulting solution evaporated to low volume and then chromatographed on a silica column eluting with methylene chloride. The fastest running red band was collected and evaporated to low volume and then methanol was added to induce crystallization. Nmr spectroscopy in methylene chloride shows the product to be the expected compound.

### Example 7

This example illustrates the preparation of emissive material with structure:

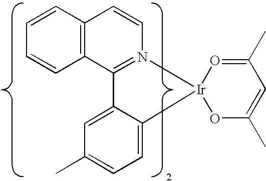

7a Preparation of the Phenylisoquinoline Ligand with Structure:

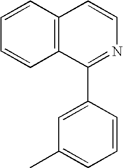

As described in Example 1a, but using a mixture of 22 g of K₂CO₃, 250 ml of degassed water, 10 g (0.06 mol) of 1-chloroisoquinoline, 8 g (0.058 mol) of 3-methylphenylboronic acid, 0.2 g of (Ph₄P)Pd, 300 mL of dimethoxyethane was refluxed for 12 h. The desired product was isolated after vacuum distillation as 6 g (46%) of liquid, which was used for the next step without further purification. ¹H NMR of isolated material was consistent with the structure indicated above.

7b Preparation of Bis-Cyclometalated Iridium Complex of Ligand 7a:

4.38 g phenylisoquinoline ligand from example 7a and 3.6 g iridium chloride were mixed in 50 mL 2-ethoxyethanol, and 2 mL water. This mixture was refluxed under nitrogen for 30 mins at which point the solution was cooled to room temperature and 1.5 g of 2,4-pentanedione and 1.0 g sodium carbonate were added as solids to the mix. Reflux was resumed for at least 30 more mins. The progress of the reaction was monitored by TLC and when judged complete the slurry was evaporated to dryness in a nitrogen stream and the resulting dark red sticky solid was collected. The solid was extracted into methylene chloride and the red solution filtered through a silica plug and the resulting solution evaporated to low volume and then chromatographed on a silica column eluting with methylene chloride. The fastest running red band was collected and evaporated to low volume and then methanol was added to induce crystallization. Nmr spectroscopy in methylene chloride shows the product to be the expected compound.

### Example 8

This example illustrates the preparation of emissive material

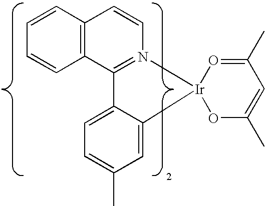

with structure:
8a Preparation of the Phenylisoquinoline Ligand with Structure:

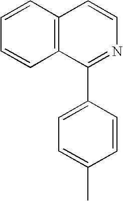

As described in Example 1a, but using a mixture of 60 g of K₂CO₃, 500 ml of degassed water, 20 g (0.122 mol) of 1-chloroisoquinoline, 17.5 g (0.128 mol) of 4-methylphenylboronic acid, 0.5 g of (Ph₄P)Pd, 400 mL of dimethoxyethane was refluxed for 12 h. 18.7 g of the desired product was isolated (70%, purity >99%) as a crystalline material, which was used for the next step without further purification. ¹H NMR of isolated material was consistent with the structure indicated above.

8b Preparation of Bis-Cyclometalated Iridium Complex of Ligand 8a:

The procedure of example 7b was followed using 4.38 g phenylisoquinoline ligand 8a and 3.6 g iridium chloride. Nmr spectroscopy in methylene chloride shows the product to be the expected compound.

### Example 9

This example illustrates the preparation of emissive material with structure:

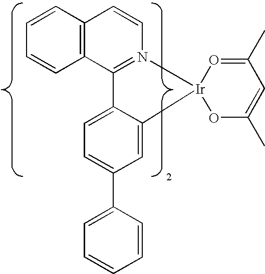

9a Preparation of the Phenylisoquinoline Ligand with Structure:

As described in Example 1a, but using a mixture of 12 g of K₂CO₃, 100 ml of degassed water, 4 g (0.024 mol) of 1-chloroisoquinoline, 5.5 g (0.027 mol) of 4-(phenyl)phenylboronic acid, 0.2 g of (Ph₄P)Pd, 200 mL of dimethoxyethane was refluxed for 12 h. 6 g of the desired product was isolated (90%, purity >96%) as a yellow crystalline material, which was used for the next step without further purification. ¹H NMR of isolated material was consistent with the structure indicated above

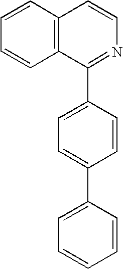

9b Preparation of Bis-Cyclometalated Iridium Complex of Ligand 9a:

The procedure of example 7b was followed using 5.62 g phenylisoquinoline ligand 9a and 3.6 g iridium chloride. Nmr spectroscopy in methylene chloride shows the product to be the expected compound.

### Example 10

This example illustrates the preparation of emissive material with structure:

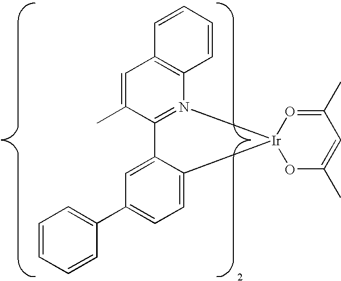

10a Preparation of the Phenylquinoline Ligand with Structure:

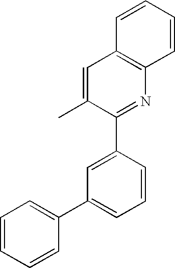

10b Preparation of Bis-Cyclometalated Iridium Complex of Ligand 10a:

The procedure of example 7b was followed using 0.60 g phenylquinoline ligand 10a and 0.36 g iridium chloride. Nmr spectroscopy in methylene chloride shows the product to be the expected compound.

### Example 11

This example illustrates the preparation of emissive material

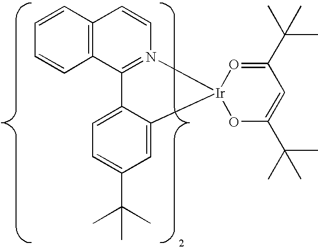

with structure:

### Example 11

This example illustrates the preparation of bis-cyclometalated iridium complex of ligand

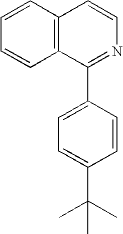

The procedure of example 7b was followed using 5.22 g phenylisoquinoline ligand shown and 3.6 g iridium chloride. 2,4-pentanedione was replaced by 2.0 g 2,2,6,6-tetramethyl-3,5-heptanedione.Nmr spectroscopy in methylene chloride shows the product to be the expected compound.

### Example 12

This example illustrates the preparation of emissive material

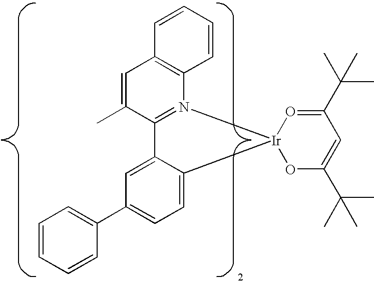

with structure:

The procedure of example 7b was followed using 3.0 g phenylquinoline ligand 10a and 1.8 g iridium chloride. 2,4-pentandione was replaced by 2.0 g 2,2,6,6-tetramethyl-3,5-heptanedione. Nmr spectroscopy in methylene chloride shows the product to be the expected compound.

### Example 13

This example illustrates the preparation of emissive material with structure:

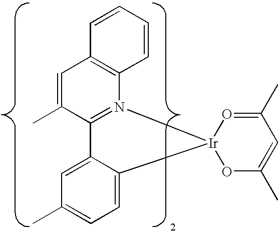

13a Preparation of the Phenylquinoline Ligand with Structure:

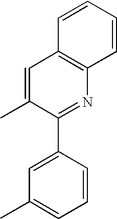

As described in Example 1a, but using a mixture of 45 g of K₂CO₃, 300 ml of degassed water, 18 g (0.1 mol) of 2-chloro-3-methylquinoline, 15 g (0.11 mol) of 3-methylphenylboronic acid, 0.3 g of (Ph₄P)Pd, 200 mL of dimethoxyethane was refluxed for 12 h. 22 g of the desired product was isolated (94%, purity >98%) as a yellow crystalline material, which was used for the next step without further purification. ¹H NMR of isolated material was consistent with the structure indicated above.

13b Preparation of Bis-Cyclometalated Iridium complex of Ligand 13a:

The procedure of example 7b was followed using 4.66 g phenylquinoline ligand 13a and 3.6 g iridium chloride. Nmr spectroscopy in methylene chloride shows the product to be the expected compound.

### Example 14

This example illustrates the preparation of emissive material with structure:

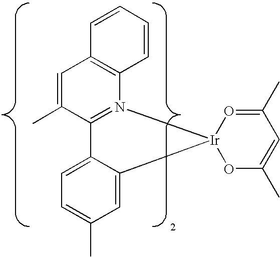

14a Preparation of the Phenylquinoline Ligand with Structure:

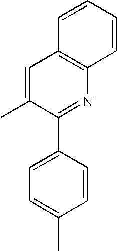

As described in Example 1a, but using a mixture of 22 g of K₂CO₃, 300 ml of degassed water, 10 g (0.056 mol) of 2-chloro-3-methylquinoline, 8 g (0.058 mol) of 4-methylphenylboronic acid, 0.3 g of (Ph₄P)Pd, 200 mL of dimethoxyethane was refluxed for 12 h. 11.5 g of the desired product was isolated (94%, purity >95%, remainder dimethoxyethane) as a yellow oil, which was used for the next step without further purification. ¹H NMR of isolated material was consistent with the structure indicated above. 14b preparation of bis-cyclometalated iridium complex of ligand 14a: The procedure of example 7b was followed using 4.66 g phenylquinoline ligand 14a and 3.6 g iridium chloride. Nmr spectroscopy in methylene chloride shows the product to be the expected compound.

### Example 15

This example illustrates the preparation of emissive material with structure:

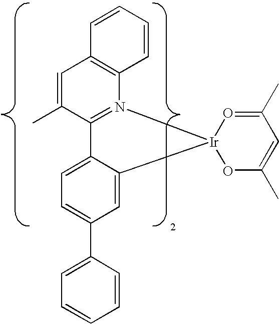

15a Preparation of the Phenylquinoline Ligand with Structure:

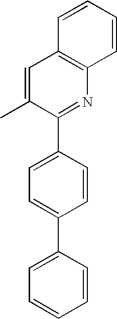

As described in Example 1a, but using a mixture of 20 g of K₂CO₃, 300 ml of degassed water, 8 g (0.045 mol) of 2-chloro-3-methylquinoline, 9.6 g (0.048 mol) of 4-(phenyl)phenylboronic acid, 0.3 g of (Ph₄P)Pd, 200 mL of dimethoxyethane was refluxed for 12 h. 6 g of the desired product was isolated (60%, purity >98%) as a crystalline material, which was used for the next step without further purification. ¹H NMR of isolated material was consistent with the structure indicated above.

15b Preparation of Bis-Cyclometalated Iridium Complex of Ligand 15a:

The procedure of example 7b was followed using 5.0 g phenylquinoline ligand 15a and 3.06 g iridium chloride. Nmr spectroscopy in methylene chloride shows the product to be the expected compound.

### Example 16

This example illustrates the preparation of emissive material

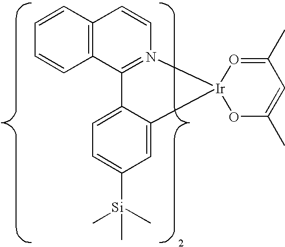

with structure:
16a Preparation of the Phenylquinoline Ligand with Structure:

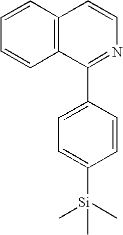

As described in Example 1a, but using a mixture of 20 g of K₂CO₃, 250 ml of degassed water, 5.7 g (0.035 mol) of 1-chloroquinoline, 7.5 g (0.033 mol) of 4-trimethylsilylphenylboronic acid, 0.2 g of (Ph₄P)Pd, 300 mL of dimethoxyethane was refluxed for 12 h. 5.8 g of the desired product was isolated (54%, 90% purity, NMR) as a yellow oil, which was used for the next step without further purification. ¹H NMR of isolated material was consistent with the structure indicated above.

16b Preparation of Bis-Cyclometalated Iridium complex of Ligand 16a:

The procedure of example 4b was followed using 2.8 g phenylisoquinoline ligand 16a and 1.8 g iridium chloride. Nmr spectroscopy in methylene chloride shows the product to be the expected compound.

### Example 17

This example illustrates the preparation of emissive material

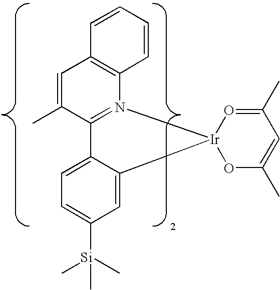

with structure:
17a Preparation of the Phenylquinoline Ligand with Structure:

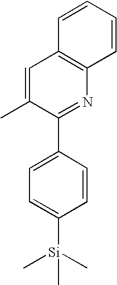

As described in Example 1a, but using a mixture of 22 g of K₂CO₃, 250 ml of degassed water, 6.2 g (0.035 mol) of 2-chloro3-methylquinoline, 7.5 g (0.038 mol) of 4-trimethylsilylphenyl-boronic acid, 0.2 g of (Ph₄P)Pd, 300 mL of dimethoxyethane was refluxed for 12 h. 8.2 g of the desired product was isolated (76%, 96% purity, NMR) as a white crystalline solid, which was used for the next step without further purification. ₁H NMR of isolated material was consistent with the structure indicated above.

17b Preparation of Bis-Cyclometalated Iridium Complex of Ligand 17a:

The procedure of example 4b was followed using 2.9 g phenylquinoline ligand 17a and 1.8 g iridium chloride. Nmr spectroscopy in methylene chloride shows the product to be the expected compound.

### Example 18

This example illustrates the preparation of emissive material with structure:

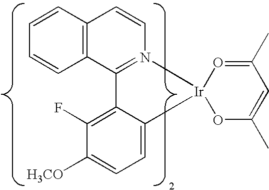

18a Preparation of the Phenylisoquinoline Ligand with Structure:

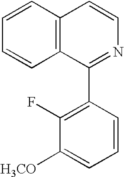

As described in Example 1a, but using a mixture of 30 g of K₂CO₃, 250 ml of degassed water, 8.5 g (0.055 mol) of 1-chloroisoquinoline, 10 g (0.065 mol) of 2-fluoro-3-methoxyphenylboronic acid, 0.3 g of (Ph₄P)Pd, 300 mL of dimethoxyethane was refluxed for 12 h. After crystallization from hexane, 12.3 g of the desired product was isolated (88%) as a white crystalline material, m.p. 107.7° C. (DSC), which was used for the next step without further purification. ¹H NMR of isolated material was consistent with the structure indicated above.

18b Preparation of Bis-Cyclometalated Iridium Complex of Ligand 18a:

The procedure of example 7b was followed using 5.06 g phenylisoquinoline ligand 18a and 3.6 g iridium chloride. Nmr spectroscopy in methylene chloride shows the product to be the expected compound.

### Example 19

This example illustrates the preparation of emissive material with structure:

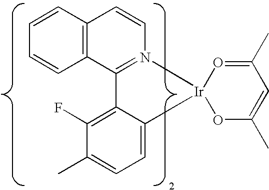

19a Preparation of the Phenylisoquinoline Ligand with Structure:

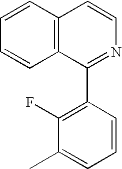

As described in Example 1a, but using a mixture of 30 g of K₂CO₃, 250 ml of degassed water, 10 g (0.061 mol) of 1-chloroisoquinoline, 10 g (0.065 mol) of 2-fluoro-3-methylphenylboronic acid, 0.3 g of (Ph₄P)Pd, 300 mL of dimethoxyethane was refluxed for 12 h. After crystallization from hexane 12.3 g of the desired product was isolated (85%) as a white crystalline material, m.p. 56.5° C. (DSC), which was used for next step without further purification. ¹H NMR of isolated material was consistent with the structure indicated above.

19b Preparation of Bis-Cyclometalated Iridium Complex of Ligand 19a:

The procedure of example 7b was followed using 4.75 g phenylisoquinoline ligand 19a and 3.6 g iridium chloride. Nmr spectroscopy in methylene chloride shows the product to be the expected compound.

### Example 20

This example illustrates the preparation of emissive material

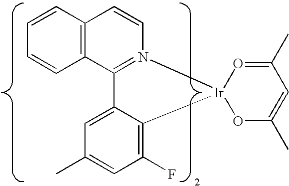

with structure:
20a Preparation of the Phenylisoquinoline Ligand with Structure:

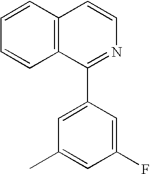

As described in Example 1a, but using a mixture of 20 g of K₂CO₃, 250 ml of degassed water, 5 g (0.03 mol) of 1-chloroisoquinoline, 10 g (0.032 mol) of 3-fluoro-5-methylphenylboronic acid, 0.3 g of (Ph₄P)Pd, 300 mL of dimethoxyethane was refluxed for 12 h. After crystallization from hexane, 8 g of the desired product was isolated (67%) as a crystalline material, which was used for the next step without further purification. ¹H NMR of isolated material was consistent with the structure indicated above.

20b Preparation of Bis-Cyclometalated Iridium Complex of Ligand 20a:

The procedure of example 7b was followed using 4.75 g phenylisoquinoline ligand 20a and 3.6 g iridium chloride. Nmr spectroscopy in methylene chloride shows the product to be the expected compound.

### Example 21

This example illustrates the preparation of emissive material

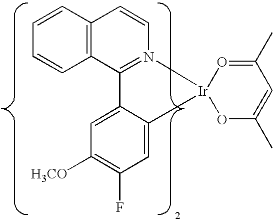

with structure:
21a Preparation of the Phenylisoquinoline Ligand with Structure:

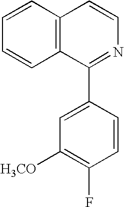

As described in Example 1a, but using a mixture of 10 g of K₂CO₃, 100 ml of degassed water, 1.7 g (0.01 mol) of 1-chloroisoquinoline, 2 g (0.012 mol) of 3-methoxy-4-fluorophenylboronic acid, 0.1 g of (Ph₄P)Pd, 300 mL of dimethoxyethane was refluxed for 12 h. After crystallization from hexane, 2.0 g of the desired product was isolated (80%) as a white crystalline material, m.p. 95.2° C. (DSC), which was used for the next step without further purification. ¹H NMR of isolated material was consistent with the structure indicated above.

21b Preparation of Bis-Cyclometalated Iridium Complex of Ligand 21a:

The procedure of example 7b was followed using 2.53 g phenylisoquinoline ligand 21a and 1.8 g iridium chloride. Nmr spectroscopy in methylene chloride shows the product to be the expected compound.

### Example 22

This example illustrates the preparation of emissive material

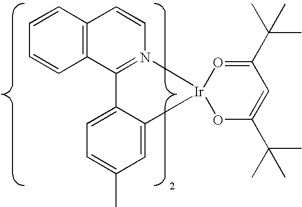

with structure:

The procedure of example 7b was followed using 4.38 g phenylisoquinoline ligand 8a and 3.6 g iridium chloride. 2.0 g of 2,2,6,6-tetramethylheptane-3,5-dione was used in place of 2,4-pentanedione. Nmr spectroscopy in methylene chloride shows the product to be the expected compound

### Example 23

This example illustrates the preparation of emissive material with structure:

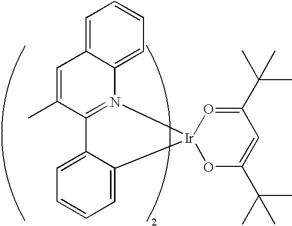

The procedure of example 7b was followed using 8.8 g 2-phenyl-3-methylquinoline ligand and 7.2 g iridium chloride. 4.0 g of 2,2,6,6-tetramethylheptane-3,5-dione was used in place of 2,4-pentanedione. Nmr spectroscopy in methylene chloride shows the product to be the expected compound.

### Example 24

This example illustrates the preparation of emissive material with structure:

OLED devices were fabricated by the thermal evaporation technique. The base vacuum for all of the thin film deposition was in the range of 10⁻⁸ torr. Patterned indium tin oxide coated glass substrates from Thin Film Devices, Inc were used. These ITO's are based on Corning 1737 glass coated with 1400 Å ITO coating, with sheet resistance of 30 ohms/square and 80% light transmission. The patterned ITO substrates were then cleaned ultrasonically in aqueous detergent solution. The substrates were then rinsed with distilled water, followed by isopropanol, and then degreased in toluene vapor.

The cleaned, patterned ITO substrate was then loaded into the vacuum chamber and the chamber was pumped down to 10⁻⁸ torr. The substrate was then further cleaned using an oxygen plasma for about 1.5 minutes. After cleaning, multiple layers of thin films were then deposited sequentially onto the substrate by thermal evaporation. Patterned metal electrodes (LiF/Al) were deposited through a mask. The thickness of the films was measured during deposition using a quartz crystal monitor. The completed OLED device was then taken out of the vacuum chamber, encapsulated with a cover glass using epoxy, and characterized.

The OLED samples were characterized by measuring their (1) current-voltage (I-V) curves, (2) electroluminescence radiance versus voltage, and (3) electroluminescence spectra versus voltage. All three measurements were performed at the same time and controlled by a computer. The current efficiency of the device at a certain voltage is determined by dividing the electroluminescence radiance of the LED by the current density needed to run the device. The unit is a cd/A. The power efficiency is the current efficiency divided by the operating voltage. The unit is Im/W.

The materials used in device fabrication are listed below:
Buffer 1 was an aqueous dispersion of poly(3,4-dioxythiophene) and a polymeric fluorinated sulfonic acid. The material was prepared using a procedure similar to that described in Example 3 of published U.S. patent application no. 2004/0254297.
Hole Transport 1 was a crosslinkable polymeric hole transport material.
NPB: N,N′-Bis(naphthalen-1-yl)-N,N′-bis-(phenyl)benzidine
Balq2: Aluminum, bis(2-methyl-8-quinolinolato-□N1, □O8)(6-phenyl-2-naphthalenolato)
ZrQ: Tetrakis-(8-hydroxyquinolinato-□N1, □O8) zirconium

### Device Configurations:

### Example 24.1

ITO substrate

Buffer 1 (48 nm)

NPB(30 nm)

red emitter in Example 1(3.2 nm) doped in balq2 (400 nm)

ZrQ(30 nm)

LiF(1 nm)

Al(100 nm)

### Example 24.7

ITO substrate

Buffer 1 (46 nm)

NPB(30 nm)

red emitter in Example 7(3.2 nm) doped in balq2 (400 nm)

ZrQ(30 nm)

LiF(1 nm)

Al(100 nm)

### Example 24.8

ITO substrate

Buffer 1 (44 nm)

NPB(30 nm)

red emitter in Example 8(3.2 nm) doped in balq2 (400 nm)

ZrQ(30 nm)

LiF(1 nm)

Al(100 nm)

### Example 24.9

ITO substrate

Buffer 1 (44 nm)

NPB(30 nm)

red emitter in Example 9(3.2 nm) doped in balq2 (400 nm)

ZrQ(30 nm)

LiF(1 nm)

Al(100 nm)

### Example 24.10

ITO substrate

Buffer 1 (47 nm)

NPB(30 nm)

red emitter in Example 10(3.2 nm) doped in balq2 (400 nm)

ZrQ(30 nm)

LiF(1 nm)

Al(100 nm)

### Example 24.12

ITO substrate

Buffer 1 (45 nm)

NPB(30 nm)

red emitter in Example 12(3.2 nm) doped in balq2 (400 nm)

ZrQ(30 nm)

LiF(1 nm)

Al(100 nm)

### Example 24.13

ITO substrate

Buffer 1 (47 nm)

NPB(30 nm)

red emitter in Example 13(3.2 nm) doped in balq2 (400nm)

ZrQ(30 nm)

LiF(1 nm)

Al(100 nm)

### Example 24.14

ITO substrate

Buffer 1 (47 nm)

NPB(30 nm)

red emitter in Example 14(3.2 nm) doped in balq2 (400 nm)

ZrQ(30 nm)

LiF(1 nm)

Al(100 nm)

### Example 24.15

ITO substrate

Buffer 1 (44 nm)

NPB(30 nm)

red emitter in Example 15(3.2 nm) doped in balq2 (400 nm)

ZrQ(30 nm)

LiF(1 nm)

Al(100 nm)

### Example 24.18

ITO substrate

Buffer 1 (49 nm)

NPB(30 nm)

red emitter in Example 18(3.2 nm) doped in balq2 (400 nm)

ZrQ(30 nm)

LiF(1 nm)

Al(100 nm)

### Example 24.20

ITO substrate

Buffer 1 (48 nm)

NPB(30 nm)

red emitter in Example 20(3.2 nm) doped in balq2 (400 nm)

ZrQ(30 nm)

LiF(1 nm)

Al(100 nm)

TABLE 24.1
device characterization data

| | | Current | Power | |
|---|---|---|---|---|
| | Peak | efficiency at | efficiency at | Color |
| | efficiency, | 500 nits, | 500 nits, | coordinates, |
| | cd/A | cd/A | Im/W | (x, y) |
| Example | 20 | 16.7 | 9 | (0.65, 0.35) |
| 24.1 | | | | |
| Example | 8.5 | 7 | 3.1 | (0.68, 0.32) |
| 24.7 | | | | |
| Example | 14 | 11.4 | 5.8 | (0.68, 0.32) |
| 24.8 | | | | |
| Example | 6 | 3.75 | 1.7 | (0.685, 0.3) |
| 24.9 | | | | |
| Example | 16 | 10.4 | 4.6 | (0.66, 0.35) |
| 24.10 | | | | |
| Example | 16 | 10.6 | 5.3 | (0.66, 0.34) |
| 24.12 | | | | |
| Example | 13 | 10.8 | 5 | (0.68, 0.32) |
| 24.13 | | | | |
| Example | 8 | 5.4 | 2.5 | (0.64, 0.35) |
| 24.14 | | | | |
| Example | 11 | 7.7 | 3.6 | (0.66, 0.33) |
| 24.15 | | | | |
| Example | 5.5 | 3.3 | 1.25 | (0.69, 0.31) |
| 24.18 | | | | |
| Example | 20 | 15.5 | 7.9 | (0.65, 0.35) |
| 24.20 | | | | |

### Example 25

### Device Fabrication and Characterization Data

OLED devices were fabricated by a combination of solution processing and thermal evaporation techniques. Patterned indium tin oxide (ITO) coated glass substrates from Thin Film Devices, Inc were used. These ITO substrates are based on Corning 1737 glass coated with 1400 Å of ITO having a sheet resistance of 30 ohms/square and 80% light transmission. The patterned ITO substrates were cleaned ultrasonically in aqueous detergent solution and rinsed with distilled water. The patterned ITO was subsequently cleaned ultrasonically in acetone, rinsed with isopropanol, and dried in a stream of nitrogen.

Immediately before device fabrication the cleaned, patterned ITO substrates were treated with O₂ plasma for 5 minutes. Immediately after cooling, an aqueous dispersion of Buffer 1 or Buffer 2 was spin-coated over the ITO surface and heated to remove solvent. After cooling, the substrates were then spin-coated with a solution of Hole Transport 1, Hole Transport 2, or Hole Transport 3, and then heated to remove solvent. After cooling the substrates were spin-coated with the emissive layer solution, and heated to remove solvent. The substrates were masked and placed in a vacuum chamber. A ZrQ layer was deposited by thermal evaporation, followed by a layer of LiF. Masks were then changed in vacuo and a layer of Al was deposited by thermal evaporation. The chamber was vented, and the devices were encapsulated using a glass lid, dessicant, and UV curable epoxy.

In Example 25.2, the host was a mixture of Balq and Host A. The Buffer was Buffer 2. The Hole transport layer used Hole Transporter 3. The emitter was the material from Example 2.

In Example 25.4, the host was a mixture of Balq and Host A. The Buffer was Buffer 1. The Hole transport layer used Hole Transporter 2. The emitter was the material from Example 4.

In Example 25.5, the host was a mixture of Balq and Host A. The Buffer was Buffer 1. The Hole transport layer used Hole Transporter 2. The emitter was the material from Example 5.

In Example 25.7, the host was a mixture of Balq and Host A. The Buffer was Buffer 1. The Hole transport layer used Hole Transporter 1. The emitter was the material from Example 7.

In Example 25.11, the host was a mixture of Balq and Host A. The Buffer was Buffer 1. The Hole transport layer used Hole Transporter 1. The emitter was the material from Example 11.

In Example 25.16, the host was a mixture of Balq and Host A. The Buffer was Buffer 2. The Hole transport layer used Hole Transporter 2. The emitter was the material from Example 16.

In Example 25.22, the host was a mixture of Balq and Host A. The Buffer was Buffer 1. The Hole transport layer used Hole Transporter 1. The emitter was the material from Example 22.

In Example 25.23, the host was a mixture of Balq and Host A. The Buffer was Buffer 1. The Hole transport layer used Hole Transporter 1. The emitter was the material from Example 23.

The OLED samples were characterized by measuring their (1) current-voltage (I-V) curves, (2) electroluminescence radiance versus voltage, and (3) electroluminescence spectra versus voltage. All three measurements were performed at the same time and controlled by a computer. The current efficiency of the device at a certain voltage is determined by dividing the electroluminescence radiance of the LED by the current density needed to run the device. The unit is a cd/A. The power efficiency is the current efficiency divided by the operating voltage. The unit is Im/W.

The materials used in device fabrication are listed below:
Buffer 1 was an aqueous dispersion of poly(3,4-dioxythiophene) and a polymeric fluorinated sulfonic acid. The material was prepared using a procedure similar to that described in Example 3 of published U.S. patent application no. 2004/0254297.
Buffer 2 was an aqueous dispersion of polypyrrole and a polymeric fluorinated sulfonic acid. The material was prepared using a procedure similar to that described in Example X of published U.S. patent application Ser. No. ______.
Hole Transport 1 was a crosslinkable polymeric hole transport material. Hole Transport 2 was a crosslinkable polymeric hole transport material. Hole Transport 3 was a crosslinkable polymeric hole transport material.

Host A:

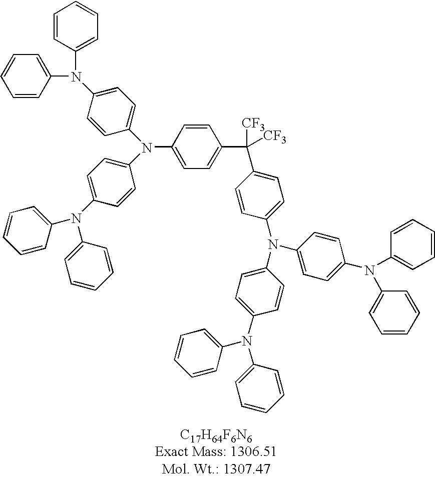

Balq: Aluminum, bis(2-methyl-8-quinolinolato-□N1, □O8)(4-phenyl-phenolato)

ZrQ: Tetrakis-(8-hydroxyquinoline) zirconium

TABLE 25.1
Device characterization data

| | Current | Power | |
|---|---|---|---|
| | efficiency | efficiency | Color |
| | at 500 nits, | at 500 nits, | coordinates, |
| | cd/A | lm/W | (x, y) |
| Example 25.2 | 14.0 | 7.6 | (0.66, 0.33) |
| Example 25.4 | 5.3 | 2.0 | (0.68, 0.32) |
| Example 25.5 | 8.6 | 3.9 | (0.68, 0.32) |
| Example 25.7 | 4.6 | 2.0 | (0.69, 0.30) |
| Example 25.11 | 9.3 | 4.5 | (0.68, 0.31) |
| Example 25.16 | 5.6 | 2.3 | (0.70, 0.30) |
| Example 25.22 | 9.8 | 4.8 | (0.68, 0.32) |
| Example 25.23 | 14.0 | 7.5 | (0.65, 0.35) |

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

What is claimed:

1. Compounds having Formula I or Formula II 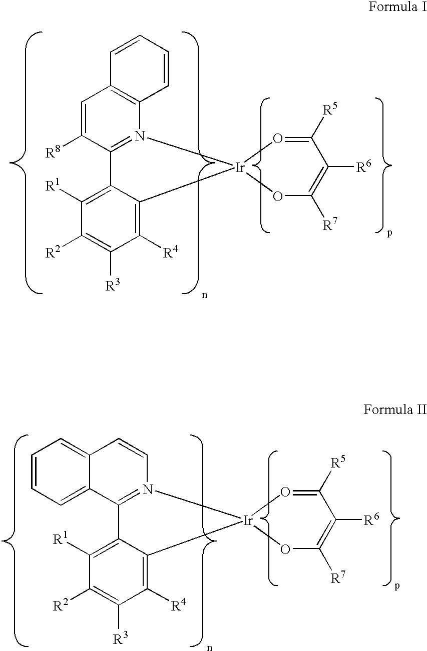
where:
n is 1, 2 or 3;
p is 0, 1 or 2;
the sum of n+p is 3;
R¹ R², R³ and R⁴ are each independently H, F, alkyl, alkoxyl, trialkylsilyl, triarylsilyl, aryl or substituted aryl.
R⁵ and R⁷ are each independently alkyl or aryl; and
R⁶ is H or alkyl.
R⁸ is H, F, or alkyl
With the proviso that at least one of R¹, R², R³, R⁴ and R⁸ is not H.

2. The compounds of claim 1 wherein R₁ and R₂ are methyl and R₃ is H.

3. The compound of claim 1 having the structure:

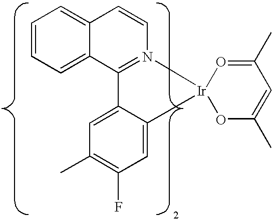

4. The compound of claim 1 having the structure:

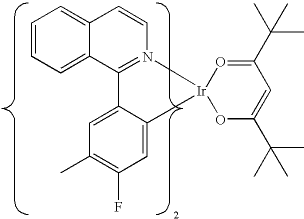

5. A composition comprising the compound of claim 1, and a solvent, a processing aid, a charge transporting material, a charge blocking material, or combinations thereof.

6. An electronic device comprising at least one layer comprising a layer comprising at least one compound of claim 1.

7. The device of claim 4 wherein the device is a light-emitting diode, a light-emitting diode display, a laser diode, a photodetector, photoconductive cell, photoresistor, photoswitch, phototransistor, phototube, IR-detector, photovoltaic device, solar cell, light sensor, photoconductor, electrophotographic device, transistor, or diode.

8. The device of claim 4 wherein the layer is a photoactive layer.

9. The device of claim 4 wherein the layer is a charge transport layer.
